(19) United States
(12) Patent Application Publication
(10) Pub. No.: US 2017/0015499 A1
(43) Pub. Date: Jan. 19, 2017

(54) Expandable and Reusable Plastic Bag

(71) Applicants: Cory Cobler, Houston, TX (US); Kelsey Cobler, Lutz, FL (US)

(72) Inventors: Cory Cobler, Houston, TX (US); Kelsey Cobler, Lutz, FL (US)

(21) Appl. No.: 15/278,488

(22) Filed: Sep. 28, 2016

Related U.S. Application Data
(60) Provisional application No. 62/236,733, filed on Oct. 2, 2015.

(51) Int. Cl. B65F 1/00; B65D 33/18; B65D 33/28; B65D 33/00; B65D 33/06

(52) U.S. Cl. CPC B65F 1/002; B65D 33/002; B65D 33/06; B65D 33/28; B65D 33/18; B65F 2250/114

(57) ABSTRACT

An expandable and reusable plastic bag is utilized. The bag is preferably a T-shirt style bag or a drawstring style bag. In either version, at least one, or a combination of, techniques are used to make the bags. The techniques include use of perforations, heat seals and adhesives (permanent and/or peelable). The bags are used to carry goods, such as groceries from the store to the home. The bags can then be opened and expanded to become trash bags, fitting into a conventionally sized trash container. The bags are thus reusable and are intended to reduce landfill and litter by virtue of their double use.

### RELATED APPLICATIONS

This application claims priority from U.S. Provisional Patent Application Ser. No. 62/236,733 having a U.S. filing date of Oct. 2, 2015, the contents of which are incorporated in its entirety herein by reference.

### BACKGROUND OF THE INVENTION

This invention relates to expandable and reusable plastic bags. More particularly, a T-shirt or drawstring plastic bag is illustrated where either a perforation, a heat seal, permanent or peelable adhesives are used to form an expandable and reusable bag. This construction enables rapid bag manufacture of the bag which results in a bag used, for example, in carrying groceries from the market. And further, the bag is expandable to form a larger bag, such as a trash bag, to fit into trash containers. This bag design and composition allows the novel bag to be reused as holding household garbage or trash and helps alleviate landfill and litter issues.

There have been previous related attempts at bag or article modification to expand or reuse a bag. These include U.S. Pat. No. 5,158,371 to Moravek and is about a self-supporting polymer bag using a rigid support to keep the bottom portion of the bag open.

U.S. Pat. No. 5,244,136 (Collaso) is directed to an expandable water-proof pouch through various folds with closures included.

U.S. Pat. No. 6,095,687 (Dematteis) discloses a gusseted foldable plastic bag.

U.S. Pat. No. 6,963,898 (Tan) discloses a tri-fold side seamed produce bag.

U.S. Pat. No. 8,821,018 (Tan) discloses merchandise bags with reinforced bag walls thinner than the thicker center section, thus supposedly providing a stronger bag bottom.

US 2005/0175812 (Mohammed) discloses a table cloth convertible to a garbage bag. The table cloth is stretched across the table top and then removed to become a garbage bag.

US 2012/0134607 (DeSmedt et al.) discloses an expandable package for compressible products.

None of these solve or address the problem of reusing a standard T-shirt grocery store bag to become a larger, useful, trash bag, making the original T-shirt bag reusable. While such T-shirt (and drawstring) plastic bags are well known in the supermarket and retail industry, these bags, without any modification, are limited in their reuse due to their size limitations and are often discarded or lost to litter.

This invention solves that problem by making the bags expandable after initial use. The expansion is accomplished by one, or a combination of, several techniques, in the design and manufacture of the bag.

### SUMMARY OF THE INVENTION

In one aspect, the invention is a thermoplastic bag comprising at least one layer, wherein the at least one layer comprises:

a first sidewall of flexible thermoplastic material;
a second sidewall of flexible thermoplastic material over-laying and joined to the first sidewall to form a first sidewall seam along a first side edge, to form a second sidewall seam along an opposite second side edge, and a closed bottom edge, the first and second sidewalls unjoined along respective top edges to define an opening opposite the closed bottom edge for accessing an interior volume;
wherein the interior volume is adjusted by folding the closed bottom edge of the bag up at least a portion of at least one bag sidewall toward the top edges and attaching the closed bottom edge to said at least one of the bag sidewalls.

The bag closed bottom edge is preferably attached to at least one of the bag sidewalls in a manner that can be detached at a later time to return the bag to its original interior volume.

At least one of the sidewalls can form a hem having a top length and extending along the open top end disposed opposite the closed bottom edge, the hem having a bottom length and at least one hem seal.

Preferably, the hem includes one or more draw tape notches and a at least one draw tape within the hem (also called the drawstring pocket herein).

Preferably, the closed bottom edge of the bag can be folded up from about 5% to about 95% of a height of at least one bag sidewall toward the top edges and attaching the closed bottom edge to said at least one of the bag sidewall.

The closed bottom edge of the bag can be attached to one of the bag sidewalls with a continuous or discontinuous strip of peelable adhesive that runs the width of the bag, adjacent to the closed bottom edge of the bag. A peelable adhesive is defined as an adhesive having a peel strength that is less than the yield strength of the substrate in which it is adhered.

The closed bottom edge of the bag can be detached from the bag sidewall by pulling the bottom edge and peeling it from the sidewall at the adhesive interface, which returns the bag to its original interior volume.

A plurality of bags comprising the bag described above is also part of the invention, preferably wherein the plurality of bags can be folded, overlapped and rolled up as a roll.

Preferably, a bottom seal running the width of the thermoplastic bag and parallel to the bottom edge of the bag is added from about 0.125 inches to about 10 inches above the bottom edge of the bag bottom. Preferably, just below the seal and adjacent about parallel to the seal, a perforation is added that runs the width of the bag. Also preferably, just below the perforation and adjacent about parallel to the perforation, a strip of continuous or discontinuous permanent adhesive running the width of the bag is added.

The closed bottom portion edge of the bag can be attached to one of the bag sidewalls with the strip of permanent adhesive. (A permeant adhesive would have a peel strength between the two substrates that is greater than the force to break or tear the bag perforation, the flap, or the perforated flap.). The bag can be detached from the bag sidewall by tearing the perforation.

The closed bottom edge of the bag can be attached to one of the bag sidewalls with at least one peelable adhesive strip (or flap herein).

The bottom portion edge of the bag is detached from the bag sidewall by peeling the adhesive strip (or flap herein) from both the bag sidewall and the bags bottom edge, hence total removal of the adhesive strip.

The bottom portion edge of the bag can be detached from the bag sidewall by peeling the adhesive strip (or flap herein) from just the bag sidewall lengthening the bag back to its original length and volume. Once lengthened, the flap can be folded over the bag bottom and reattached to opposite bag sidewall encapsulating the bag bottom.

The closed bottom edge of the bag can be attached to one of the bag sidewalls with a permanent adhesive strip (or flap herein).

The bottom portion of the bag can be detached from the bag sidewall by tearing the adhesive strip (also called the flap herein), leaving about half of the strip attached to the sidewall of the bag.

The closed bottom edge of the bag can be attached to one of the bag sidewalls with a velcro strip.

The bottom portion of the bag can be detached from the bag sidewall by separating the velcro style strip leaving half of the strip on the bag body and the other half on the bottom of the bag.

The closed bottom edge of the bag can be attached to one of the bag sidewalls with at least one perforated strip.

The bottom portion of the bag can be detached from the bag sidewall by tearing the adhesive strip (also called the flap herein) at the perforation, leaving about half of the strip attached to the sidewall of the bag.

The closed bottom edge of the bag can be attached to one of the bag sidewalls with a strip that contains a built in tear strip.

The bottom portion of the bag can be detached from the bag sidewall by tearing the adhesive strip (also called the flap herein) with the built in tear strip leaving about half of the strip attached to the sidewall of the bag.

Preferably, the strip (also called the flap herein) could be printed.

Preferably, the strip (also called the flap herein) could be a natural color or pigmented any color.

Preferably, the strip (also called the flap herein) could have a serrated edge or a “V” notch to help initiate the tearing of the flap.

Preferably, the strip (also called the flap herein) could be made from a thermoplastic film, or a machine direction oriented thermoplastic, or a filled machine direction oriented thermoplastic film.

Preferably, the strip (also called the flap herein) could be made from paper.

Preferably, the strip (also called the flap herein) could be supplied on a master roll as a continuous flap and perforated across the width of the flap as it is unwound. Either before or after the perforation a continuous or discontinuous coating of a permanent or peelable adhesive could be applied to the flap. The spacing of the perforations down the length of the flap could match the width of the bag so that it can be applied in a continuous process where the perforation of the flap would be line up with the perforation of the bag so they could both be broke at the same time in the process.

Preferably, the strip (also called the flap herein) could be supplied on a master roll as a continuous flap that was pre coated with a continuous or discontinuous coating of a permanent or peelable adhesive and perforated across the width of the flap as it is unwound. The spacing of the perforations down the length of the flap could match the width of the bag so that it can be applied in a continuous process where the perforation of the flap would be line up with the perforation of the bag so they could both be broke at the same time in the process.

Preferably, the bag could be printed.

Preferably, the bag would have a patch handle.

Preferably, the bag would have a wave top.

Preferably, the bag would have a die cut handle.

Preferably, the bag would have a die cut handle in the hem portion of the bag.

Preferably, the bag would have a ridged reinforced die cut handle.

Preferably, the bag could be supplied with a twist tie attached.

Preferably, at least one looped handle or straight handle is attached to the top edge of the bag up to about 40% of the bag's height below the top edge of the bag above the bags hem seal. The handle can be positioned so the apex of the loop or the center of the straight handle is centered in the width of the bag. The apex of the looped handles or centers of the straight handles can be located about 50% of the width of the bag.

Preferably, the bag would be individually folded.

Preferably, a plurality of bags could be attached by a perforation, folded and rolled up as a roll.

Preferably, a plurality of bags could be folded, overlapped and rolled up as a roll.

Preferably, a plurality of bags could be stacked and attached with a wicket or header.

Preferably, the bag would contain a combination of any of the described handle types, bag tops, gussets, and attaching and detaching methods.

In another aspect, the invention is a thermoplastic bag comprising:

a first sidewall of flexible thermoplastic material;
a second sidewall of flexible thermoplastic material over-laying and joined to the first sidewall to form a first sidewall seem along a first side edge, to form a second sidewall seam along an opposite second side edge, and a closed bottom edge, the first and second sidewalls unjoined along respective top edges to define an opening opposite the bottom edge for accessing the interior volume; wherein the interior volume can be adjusted by folding the top edges of the bag down by using a secondary set of handles that are positioned 33% of the bags height below the primary handles.

Preferably, the bottom edge of the bag is attached to at least one of the bag sidewalls in a manner that can be detached at a later time to return the bag to its original volume. At least one of the sidewalls can form a hem having a top length and extending along the open top end disposed opposite the bottom edge, the hem having a bottom length and at least one hem seal.

Preferably, the hem including one or more draw tape notches and at least one draw tape within the hem (also called the drawstring pocket herein).

The bag further can further comprise a bottom gusset to form a flat bottom.

At least one looped handle can be attached to the inside or the outside of one of the sidewalls of the bag toward the middle of the bag from about 5% to about 95% of the bag height. At least one looped handle can be attached to the inside or the outside of both the first and second bag sidewalls.

At least one straight handle can be attached to the inside or the outside of one of the sidewalls of the bag toward the middle of the bag from about 5% to about 95% of the bag height. At least one straight handle can be attached to the inside or the outside of both the first and second bag sidewalls.

Preferably, at least one thermoplastic strip handle can be located, or run, parallel to the machine direction, attached to the width of the bag and located about 5% to about 95% of the bag height, on either the inside or outside of the bags sidewalls and is sealed into the sidewall seams.

Preferably, the bag would have a patch handle.

Preferably, the bag would have a wave top.

Preferably, the bag would have a die cut handle.

Preferably, the bag would have a die cut handle in the hem portion of the bag.

Preferably, the bag would have a ridged reinforced die cut handle.

Preferably, the bag could be printed.

Preferably, the bag could be supplied with a twist tie attached.

Preferably, the bag would be individually folded.

Preferably, a plurality of bags could be attached by a perforation, folded and rolled up as a roll.

Preferably, a plurality of bags could be folded, overlapped and rolled up as a roll.

Preferably, a plurality of bags could be stacked and attached with a wicket or header.

Preferably, the bag would contain a combination of any of the described handle types, gussets, and bag tops.

In yet another aspect, the invention is a thermoplastic bag having front and rear walls, each of said front and rear walls having first and second side edges, a top edge and a bottom edge;

said front and rear walls being integrally joined at their first and second side edges and secured together at their bottom edge by a lower seam across the width of said bags to form a closed bottom edge; the front and rear walls unjoined along respective top edges to define an opening opposite the bottom edge for accessing an interior volume;
wherein the interior volume is adjusted by folding the closed bottom edge of the bag up at least a portion of at least one bag sidewalls (front or rear walls) toward the top edges and attaching the closed bottom edge to said at least one of the bag front or rear sidewalls.

The bag bottom is preferably attached to at least one of the bag sidewalls (Front or Rear walls) in a manner that can be detached at a later time to return the bag to its original volume.

Preferably, the bottom edge of the bag is attached to at least one of the bag sidewalls (Front or Rear walls) in a manner that can be detached at a later time to return the bag to its original volume. The top edge of the front and rear walls are secured together by an upper seam across the width of the bag. The bag has longitudinally oriented side gussets adjacent said first and second side edges and a U-shaped cut-out. The U-shaped cut-out being disposed in an upper portion of said bag and commencing at a first point along said upper seam spaced inwardly from said first side edge and extending to a second point along the upper seam spaced inwardly from said second side edge, said cut-out extending downwardly toward said bottom edges, thereby forming an open mouth portion and a pair of bag handles. Such a bag is widely known as a “T-shirt bag.”

At least one of the seamed bottom edges of the bag can be folded up from about 5% to about 95% of a height of at least one bag sidewalls (Front or Rear walls) toward the top edges and attaching the closed bottom edge to said at least one of the bag sidewalls (Front or Rear walls).

The closed bottom edge of the bag can be attached to one of the bag sidewalls (Front or Rear walls) with a strip of continuous or discontinuous peelable (A peelable adhesive being defined as having a peel strength that is less than the yield strength of the substrate in which it is adhered) adhesive that runs the width of the bag, adjacent to the bottom edge of the bag.

The bottom edge of the bag can be detached from the bag sidewalls (Front or Rear walls) by pulling the bottom edge and peeling it from the sidewall (front or rear wall) at the adhesive interface, which returns the bag to its original volume.

Preferably, a perforation running the width of the thermoplastic bag and parallel to the bottom edge of the bag is added just below the seal. Preferably, just below the perforation and adjacent about parallel to the perforation a strip of continuous or discontinuous permanent adhesive running the width of the bag is added.

The bottom portion edge of the bag can be attached to one of the bag sidewalls (Front or Rear walls) with the strip of permanent adhesive. (A permeant adhesive would have a peel strength between the two substrates that is greater than the force to break or tear the bag perforation, the flap, or the perforated flap.). The bag is detached by tearing the perforation.

The closed bottom edge of the bag can be attached to one of the bag sidewalls (Front or Rear walls) with a velcro strip.

The bottom portion of the bag can be detached from the bag sidewalls (Front or Rear wall) by separating the velcro style strip leaving half of the strip on the bag body and the other half on the bottom of the bag.

The closed bottom edge of the bag can be attached to one of the bag sidewalls (Front or Rear walls) with at least one peelable adhesive strip (or flap herein).

The bottom portion edge of the bag is detached from the bag sidewall (front or rear wall) by peeling the adhesive strip (or flap herein) from both the bag sidewall and the bags bottom edge, hence total removal of the adhesive strip.

The bottom portion edge of the bag is detached from the bag sidewall (front or rear wall) by peeling the adhesive strip (or flap herein) from just the bag sidewall lengthening the bag back to its original length and volume. Once lengthen the flap can be folded over the bag bottom and reattached to opposite bag sidewall encapsulating the bag bottom and the intersection points of the bag's gussets and bottom seal strengthening a known weak spot of this style of bag.

The closed bottom edge of the bag can be attached to one of the bag sidewalls (Front or Rear walls) with a permanent adhesive strip (or flap herein).

The bottom portion of the bag can be detached from the bag sidewall (Front or Rear wall) by tearing the adhesive strip (also called the flap herein), leaving about half of the strip attached to the sidewall of the bag.

The closed bottom edge of the bag can be attached to one of the bag sidewalls (Front or Rear walls) with at least one perforated strip (or flap herein).

The bottom portion of the bag can be detached from the bag sidewall (Front or Rear wall) by tearing the adhesive strip (also called the flap herein) at the perforation, leaving about half of the strip attached to the sidewall of the bag.

The closed bottom edge of the bag can be attached to one of the bag sidewalls (Front or Rear walls) with a strip that contains a built in tear strip.

The bottom portion of the bag can be detached from the bag sidewall (Front or Rear wall) by tearing the adhesive strip (also called the flap herein) with the built in tear strip leaving about half of the strip attached to the sidewall of the bag.

Preferably, the strip (also called the flap herein) could be printed.

Preferably, the strip (also called the flap herein) could be a natural color or pigmented any color.

Preferably, the strip (also called the flap herein) could have a serrated edge or a “V” notch to help initiate the tearing of the flap.

Preferably, the strip (also called the flap herein) could be made from a thermoplastic film, or a machine direction oriented thermoplastic film, or a filled machine direction oriented thermoplastic film.

Preferably, the strip (also called the flap herein) could be made from paper.

Preferably, the bag could be printed.

Preferably, at least one of the front and rear side walls edges are secured together with a seam the length of the bag.

Preferably, the bag having at longitudinally oriented side gussets adjacent said first and second side edges.

Preferably, the bag having a slotted tab integrally attached to the front and rear walls at the top edge of the bag in the center of the handles.

Preferably, the bag having a perforated slotted tab integrally attached to the front and rear walls at the top edge of the bag in the center of the handles.

Preferably, the bag having a slot or hole in each of the handle areas to allow them to be hung on a rack.

Preferably, the bag would be individually folded.

Preferably, a plurality of bags, comprising the bag described above, could be attached by a perforation, folded and rolled up as a roll.

Preferably, the plurality of bags could be folded, overlapped and rolled up as a roll.

Preferably, the plurality of bags could be stacked and attached by their slotted tab so the stack of bags could be hung on a rack and individually dispensed by tearing the individual bag form the rack by breaking the tab leaving it attached to the bag.

Preferably, the plurality of bags could be stacked and attached by their slotted perforated tab so the stack of bags could be hung on a rack and individually dispensed by tearing the individual bag from the tab at the perforation leaving the tab on the rack.

Preferably, the bag would have a patch handle.

Preferably, the bag would have a wave top.

Preferably, the bag would have a die cut handle.

Preferably, the bag would have a ridged reinforced die cut handle.

Preferably, the bag would contain a combination of any of the described handle types, bag tops, gussets, and attaching and detaching methods.

### BRIEF DESCRIPTION OF THE DRAWINGS

FIGS. 1A, 1B, 1C, and 1D are schematic representations of a T-Shirt bag of the invention in various stages of formation having one seal, one perforation, and one permanent adhesive.

FIGS. 2A, 2B, and 2C illustrates a T-Shirt bag of the invention in various stages of formation having one seal, and one peelable adhesive.

FIGS. 3A, 3B, 3C and 3D illustrates a drawstring bag of the invention in various stages of formation having one seal, one perforation and one permanent adhesive.

FIGS. 4A, 4B and 4C illustrates a drawstring bag of the invention in various stages of formation having one peelable adhesive.

FIGS. 5A and 5B illustrates a drawstring bag of the invention in various stages of formation plus handles attached to top.

FIGS. 6A, 6B, 6C and 6D illustrates a drawstring bag of the invention in various stages of formation having a bottom gusset, and additional handles inside the bag.

FIGS. 7A, 7B, 7C and 7D illustrates a drawstring bag of the invention in various stages of formation having a bottom gusset, and additional looped handles inside the bag.

FIGS. 8A, 8B, and 8C illustrates a T-Shirt bag of the invention in various stages of formation having a peelable flap.

FIGS. 9A, 9B, and 9C illustrates a T-Shirt bag of the invention in various stages of formation having a permanent perforated flap.

FIGS. 10A, 10B, and 10C illustrates a drawstring bag of the invention in various stages of formation having a peelable flap.

FIGS. 11A, 11B, and 11C illustrates a drawstring bag of the invention in various stages of formation having a permanent perforated flap.

FIGS. 12A, 12B, and 12C illustrates a drawstring bag of the invention in various stages of formation having a permanent flap.

### DESCRIPTION OF THE SPECIFIC EMBODIMENTS

Film Manufacture

Film can be made or manufactured using conventional techniques, such as blown film, cast film and the like. Blown film lines can be monolayer or two or more layers of film, such as two, three and even four or more film layers. The blow up ratio of the film is typically selected for the desired strength and thickness of the resulting film, but is usually between about 1:1 to about 5:1, preferably from about 1.5:1 to about 3:1. Typical final film thickness is dependent upon desired use. For retail stores selling relatively heavy goods, the film thickness may be on the thicker side, for example, from 2 to 10 mils. Other film thickness for standard grocery stores can be from 0.5 mils to about 5 mils.

As indicated, the film can be monolayer, and is preferred. However, the film can also be multilayer, with differing polymers present in different layers. Sometimes, these different polymers perform different functions. One layer may be a water and/or oxygen barrier layer, while another layer may provide overall strength (but lack the barrier properties). One example of a barrier polymer (made into film) is ethylene/acrylic acid copolymers such as PRIMACOR* EAA Resins, a trademark of and made by The Dow Chemical Company.

In the case of multilayer films, the layers need not be the same thickness, although the thicknesses are usually about the same (+/−10% of each other thickness).

Film and film structures particularly benefit from the novel compositions described herein and can be made using conventional hot blown film fabrication techniques or other biaxial orientation processes such as tenter frames or double bubble processes.

Conventional hot blown film processes are described, for example, in The Encyclopedia of Chemical Technology, Kirk-Othmer, Third Edition, John Wiley &amp; Sons, New York, 1981, Vol. 16, pp. 416-417 and Vol. 18, pp. 191-192. Biaxial orientation film manufacturing process such as described in a “double bubble” process as in U.S. Pat. No. 3,456,044 (Pahlke), and the processes described in U.S. Pat. No. 4,352,849 (Mueller), U.S. Pat. No. 4,597,920 (Golike), U.S. Pat. No. 4,820,557 (Warren), U.S. Pat. No. 4,837,084 (Warren), U.S. Pat. No. 4,865,902 (Golike et al.), U.S. Pat. No. 4,927,708 (Herran et al.), U.S. Pat. No. 4,952,451 (Mueller), U.S. Pat. No. 4,963,419 (Lustig et al.), and U.S. Pat. No. 5,059,481 (Lustig et al.), the disclosures of which are incorporated herein by reference, can also be used to make film structures from the novel compositions described herein.

Stretching of film is a method used to enhance film properties or film attributes. A common way of stretching film is a process known as machine direction orienting (MDO). Another way is incrementally stretching film in the machine direction, cross direction or diagonal direction. Often, incremental stretching is referred to as ring rolling. With modifications the ring rolling process can make structural elastic like film (“SELF”). These different orientation processes can be preform with or without heat added.

Lamination or bonding of films is also a method used to enhance film properties or film attributes. Methods of lamination/bonding include cold bonding where the films are stretched and bonded simultaneously, adhesively bonding, heat bonding and extrusion bonding. These processes can laminate/bond the films in a continuous or discontinuous fashion.

Combining films that have been stretched/orientated via one of the described lamination/bonding processes is a method to enhance film properties or film attributes.

Film structures can also be made breathable utilizing methods such as microperforating the film or by caveating a film which can be done utilizing the ring rolling process. Both of these methods allow the films to breath while not letting water droplets pass through the film.

The film structures can also be made as described in a tenter-frame technique, such as that used for oriented polypropylene.

Other multi-layer film manufacturing techniques for food packaging applications are described in Packaging Foods With Plastics, by Wilmer A. Jenkins and James P. Harrington (1991), pp. 19-27, and in “Coextrusion Basics” by Thomas I. Butler, Film Extrusion Manual: Process, Materials, Properties pp. 31-80 (published by TAPPI Press (1992)).

The films may be monolayer or multilayer films. The film made from the compositions can also be coextruded with the other layer(s) or the film can be laminated onto another layer(s) in a secondary operation, such as that described in Packaging Foods With Plastics, by Wilmer A. Jenkins and James P. Harrington (1991) or that described in “Coextrusion For Barrier Packaging” by W. J. Schrenk and C. R. Finch, Society of Plastics Engineers RETEC Proceedings, Jun. 15-17 (1981), pp. 211-229. If a monolayer film is produced via tubular film (blown film techniques) or flat die (cast film) as described by K. R. Osborn and W. A. Jenkins in “Plastic Films, Technology and Packaging Applications” (Technomic Publishing Co., Inc. (1992)), then the film may go through an additional post-extrusion step of adhesive or extrusion lamination to other packaging material layers to form a multilayer structure. If the film is a coextrusion of two or more layers (also described by Osborn and Jenkins), the film may still be laminated to additional layers of packaging materials, depending on the other physical requirements of the final film. “Laminations vs. Coextrusion” by D. Dumbleton (Converting Magazine (September 1992), also discusses lamination versus coextrusion. Monolayer and coextruded films can also go through other post extrusion techniques, such as a biaxial orientation process.

Extrusion coating of the thermoplastic film can also be used, and in this instance, the added layer(s) need not be thermoplastic. It could be non-thermoplastic such as foil or paper. Extrusion coating is another technique for producing multilayer film structures using the novel compositions described herein. The compositions comprise at least one layer of the film structure. Similar to cast film, extrusion coating is a flat die technique. A sealant can be extrusion coated onto a substrate either in the form of a monolayer or a coextruded extrudate.

Generally for a multilayer film structure, the compositions described herein comprise at least one layer of the total multilayer film structure. Other layers of the multilayer structure include but are not limited to barrier layers, and/or tie layers, and/or structural layers. Various materials can be used for these layers, with some of them being used as more than one layer in the same film structure. Some of these materials include: nylon, ethylene/vinyl alcohol (EVOH) copolymers, polyvinylidene chloride (PVDC), polyethylene terephthalate (PET), polypropylene, oriented polypropylene (OPP), ethylene/vinyl acetate (EVA) copolymers, ethylene/acrylic acid (EAA) copolymers, ethylene/methacrylic acid (EMAA) copolymers, LLDPE, HDPE, LDPE, nylon, graft adhesive polymers (for example, maleic anhydride grafted polyethylene), foil and paper. Generally, the multilayer film structures comprise from 2 to 7 layers.

At least a portion of the film (or bag walls) can be corona treated to improve adhesion, such as for printing or label application. Corona treatment is disclosed, for example in U.S. Pat. No. 5,688,465 (Myers), and U.S. Pat. No. 5,972,176 (Kirk et al.), the disclosures of which are incorporated herein by reference. All of the articles disclosed herein are also incorporated herein by reference.

Polymer Selection

The films used to make the bags disclosed herein are typically thermoplastic in nature. That is, the polymer(s) chosen for film manufacture are capable of being melted, at least partially, and extruded through a die to make a film layer. Typical polymers which can be used for the film layer(s) includes polyethylene and its copolymers, polypropylene and its copolymers. Polyethylene comes in many varieties and the variety dictates the performance properties of the film. These polyethylene types include low density polyethylene (LDPE), linear low density polyethylene (LLDPE) (such as DOWLEX* (a trademark of and made by The Dow Chemical Company)), high density polyethylene (HDPE), substantially linear but long chain branched polyethylene such as AFFINITY* or ENGAGE* polyethylene, (trademarks of and made by The Dow Chemical Company). Copolymers of ethylene and at least one alpha-olefin are preferred. More preferred copolymers include ethylene/1-butene, or ethylene/1-hexene, or ethylene/1-octene; mixtures of these copolymers are also included, as are terpolymers.

The molecular weight of the polyethylene is typically indicated by melt index (measured using ASTM D1238, Condition 190/2.16), and is selected according to the final desired film properties and the manufacturing techniques selected. Typical melt index useful for film manufacture (blown or cast) is from about 0.2 grams/10 minutes to about 10 grams/10 minutes. Mixtures of molecular weight polymers can also be used, so long as they can be made into films. Mixing molecular weights can also have the effect of changing, usually broadening, the molecular weight distribution (MWD). So long as the film can be made, MWD of the polymers used can be narrow or broad.

For polyethylene (PE) especially, density can be varied according to the end use requirements. For example, when a stiffer film is desired, HDPE is selected having a density from about 0.945 g/cm³ to about 0.962 g/cm³. For softer and quitter films, PE density from about 0.86 g/cm³ to about 0.945 g/cm³ is chosen. Density for polyethylene is usually measured in accordance with ASTM D-792.

Example patents disclosing various polyethylenes include U.S. Pat. No. 5,272,236 (Lai et al), U.S. Pat. No. 5,278,272 (Lai et al) and U.S. Pat. No. 4,076,698 (Anderson et al), the disclosures of which are incorporated herein by reference.

Propylene polymers and copolymers such as VERSIFY* (a trademark of and made by The Dow Chemical Company), can also be used in the invention.

Other thermoplastic polymers include, but are not limited to thermoplastic urethanes, such as PELLATHANE* (a trademark of and made by The Dow Chemical Company).

Adhesive Selection

There are several different types of adhesive technologies such as hot melt adhesives, solvent based adhesives, water based adhesives, pressure sensitive adhesives and reactive chemistry adhesive to name a few. These different adhesives can be made from base materials such as acrylics, epoxies, urethane, natural rubber, synthetic rubber, latex, and thermal plastics. Most all adhesive system are formulated to optimize properties such as adhesion force to desired substrate, application temperature, viscosity, as well as physical strength properties of the adhesive itself. There are several different application methods for applying these different adhesives. Some of these would include spraying, dispensing nozzle, roll coating, transfer printing, curtain coating, extrusion coating or applying as a solid.

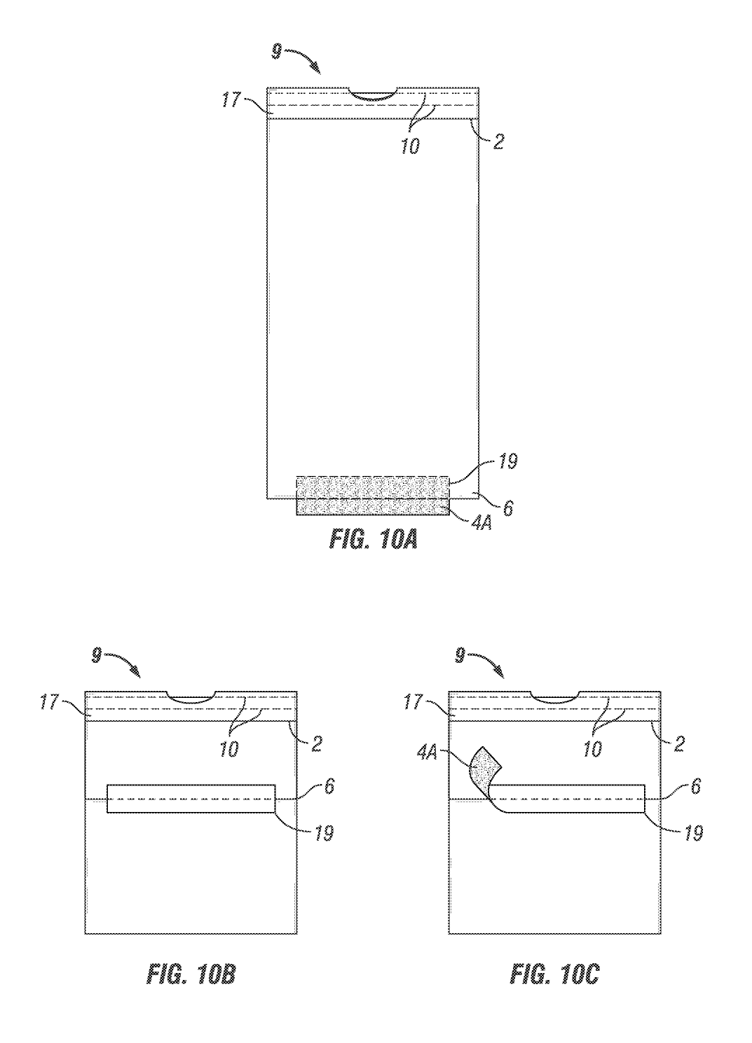

In this application, a 2 inch wide flap from Weber Packing Solution, Inc. was used to make the bag shown in FIG. 10. This flap had a pressure sensitive peelable adhesive which was applied to a bi axially oriented polypropylene (BOPP) substrate that was 2 mils thick. The adhesive was a water based acrylic. The flap was applied the width of a drawstring trash bag using 30 psi of pressure (FIGS. 10A & 10B). This peelable adhesive flap allowed the drawstring bag to carry in excess of 25 lbs. when in its reduced volume configuration (FIG. 10B) and then was able to be removed (FIG. 10C) from the bag allowing it to be lengthen back to its original volume.

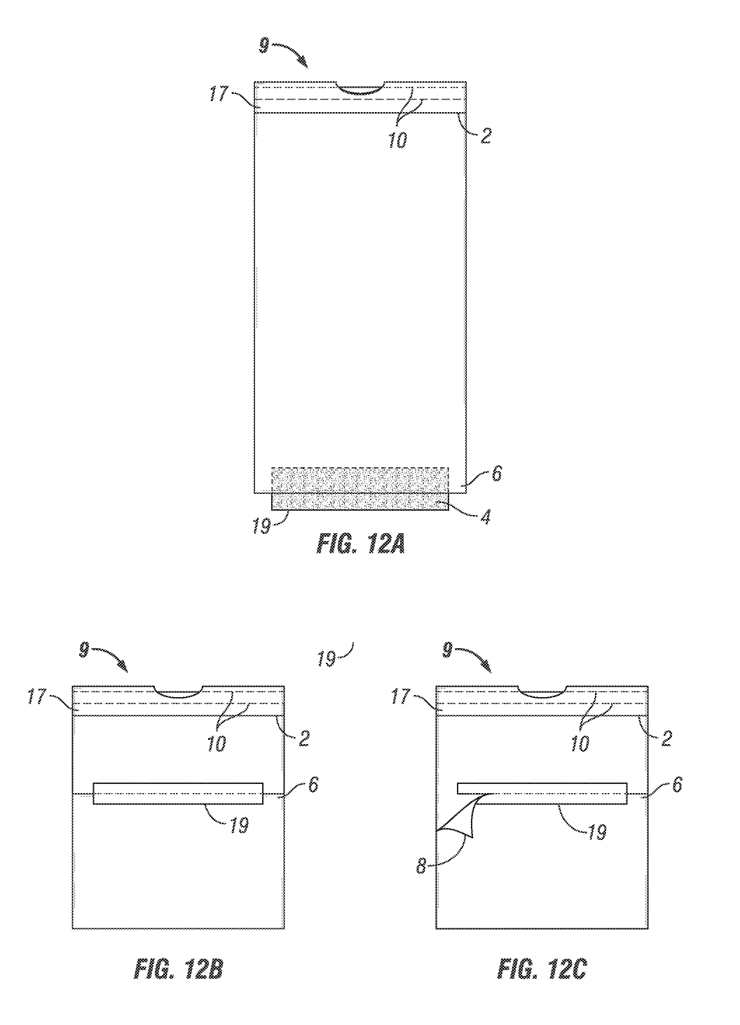

In this application, a 2 inch wide flap from Weber Packing Solution, Inc. was used to make the bag shown in FIG. 12. This flap had a pressure sensitive permanent adhesive which was applied to a 3 mil thick paper substrate. The adhesive was a water based natural rubber. The flap was applied the width of a drawstring trash bag using 30 psi of pressure (FIGS. 12A & 12B). This permanent adhesive flap allowed the drawstring bag to carry in excess of 25 lbs. when in its reduced volume configuration (FIG. 12B) and then was able to be torn (FIG. 12C) leaving half of the flap on the bag body and half of the flap on the bag bottom allowing the bag to be lengthen back to its original volume.

Adhesive Definitions—

Adhesive strength can be measured using a peal test like described in ASTM D3330. For definition purposes in this patent a peelable adhesive would have a peel strength that is less than the yield strength of the substrate it is adhered too. A permanent adhesive would have a peel strength between the two substrates that is greater than the force required to break or tear the bag perforation, the flap, or the perforated flap.

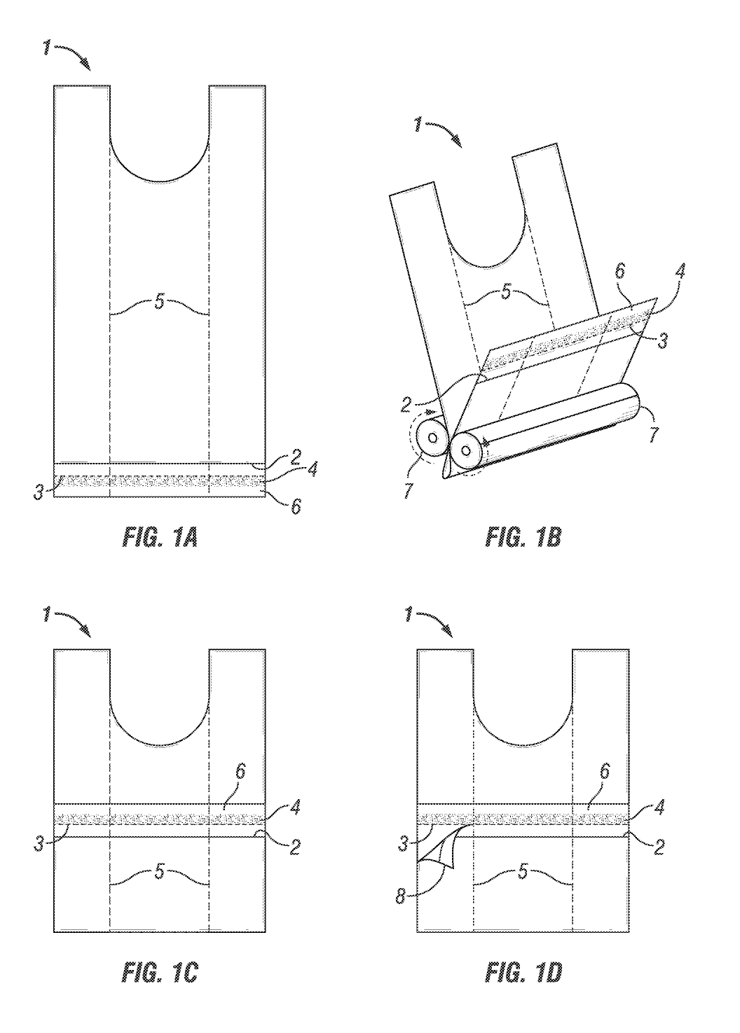

FIGS. 1A, 1B, 1C, 1D: T-Shirt Bag: One Seal, One Perforation, One Permanent Adhesive.

FIG. 1A depicts a T-shirt style trash bag 1. The bag has a seal 2 near the bottom that is the width of the bag with a perforated section 3 below it also the width of the bag. The perforated section 3 could technically be the width of the bag or anything less than the width of the bag. The perforation spacing and size may vary depending on the desired break force strength. Below the perforation but above the bag bottom or bag tail 6 is a permanent adhesive 4 is applied across the width of the bag. The permanent adhesive 4 can be applied as a continuous or discontinuous strip. A pair of gussets 5 are also shown in FIG. 1.

Once the bag has these applications as shown in FIG. 1A, it is then folded through a pair of nipped rollers 7 shown in FIG. 1B. The nipped rollers 7 apply a pressure that adheres the bottom of the bag to the bag's body resulting in a lesser volume as depicted in FIG. 1C. The bottom of this smaller bag is the folded area (below tail 6). The volume of the smaller bag will vary based on where the original bag is folded. The suitable volume will be one that is ideal for a carry out bag. Once the bag has been used for its initial purpose, the perforation 3 can then be torn or peeled back using bag corner 8, as shown in FIG. 1D, to extend the bag back to its original length and volume. The tail end 6 of the original bag (that was folded and adhered to the bag body) would remain attached to the side of the bag. The seal 2 above the perforation 3 (in the extended orientation) would become the bottom of the larger bag. The bag would now be a suitable size to be used as a trash bag.

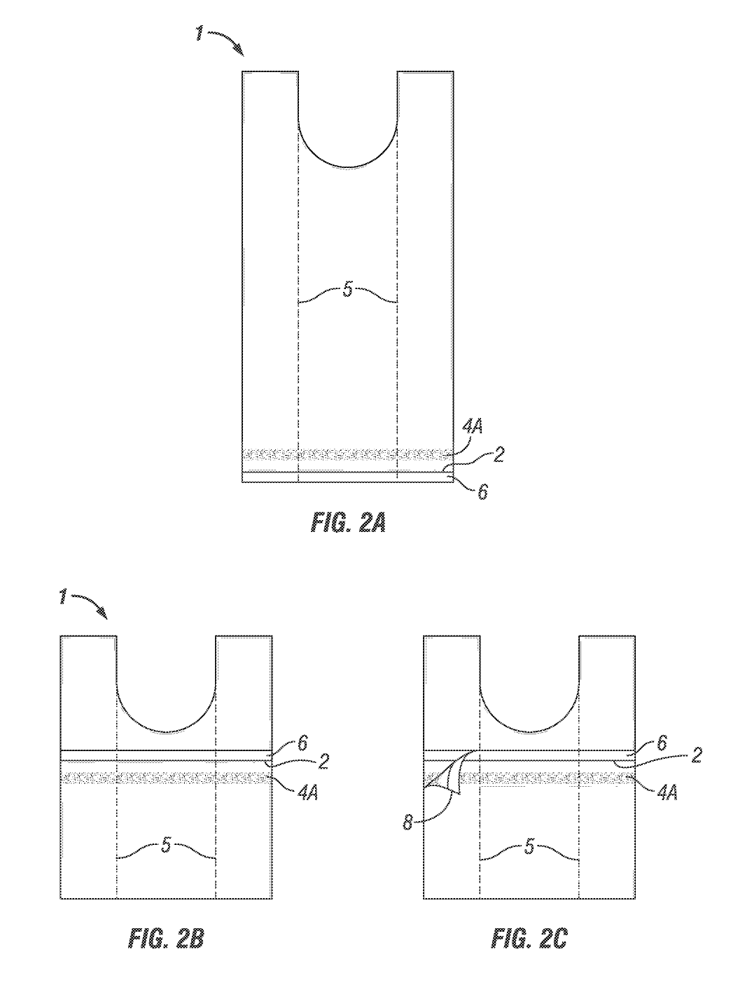

FIGS. 2A, 2B, 2C: T-Shirt Bag: One Seal, One Peelable Adhesive

FIG. 2A depicts a design similar to that of FIG. 1 in which a T-shirt style trash bag 1 is folded and the bottom of the bag is attached to the body, but is done so using a peelable adhesive 4A rather than a perforation (3 in FIG. 1A, 1B, 1C, 1D, but not shown in FIG. 2A, 2B, 2C because not used and/or needed). The bag has a seal 2 at the bottom/tail 6 of the bag that is the width of the bag. A peelable adhesive 4A is applied either above or overlapping the seal 2 that is the width of the bag. The adhesive could technically be the width of the bag or anything less than the width of the bag. Once the bag has these applications (FIG. 2A), it is then folded through a pair of nipped rollers (pictured in FIG. 1B as 7). The nipped rollers apply a pressure that adheres the bottom of the bag to the bag's body resulting in a lesser volume (FIG. 2B). The bottom of this smaller bag is the folded area (below tail 6). The volume of the smaller bag will vary based on where the original bag is folded. The suitable volume will be one that is ideal for a carry out bag. Once the bag has been used for its initial purpose, the attached original bag bottom can be peeled from the bag body via bag corner 8 using peelable adhesive 4A (FIG. 2C) to extend the bag back to its original length and volume. The seal 2 made at the bottom of the original bag would function as the bottom of the extended bag. The bag would now be a suitable size to be used as a trash bag.

The shear strength of the adhesive during first use needs to be capable of supporting the original load in the smaller volume bag and can after be peeled back in order to extend the bag to its original volume.

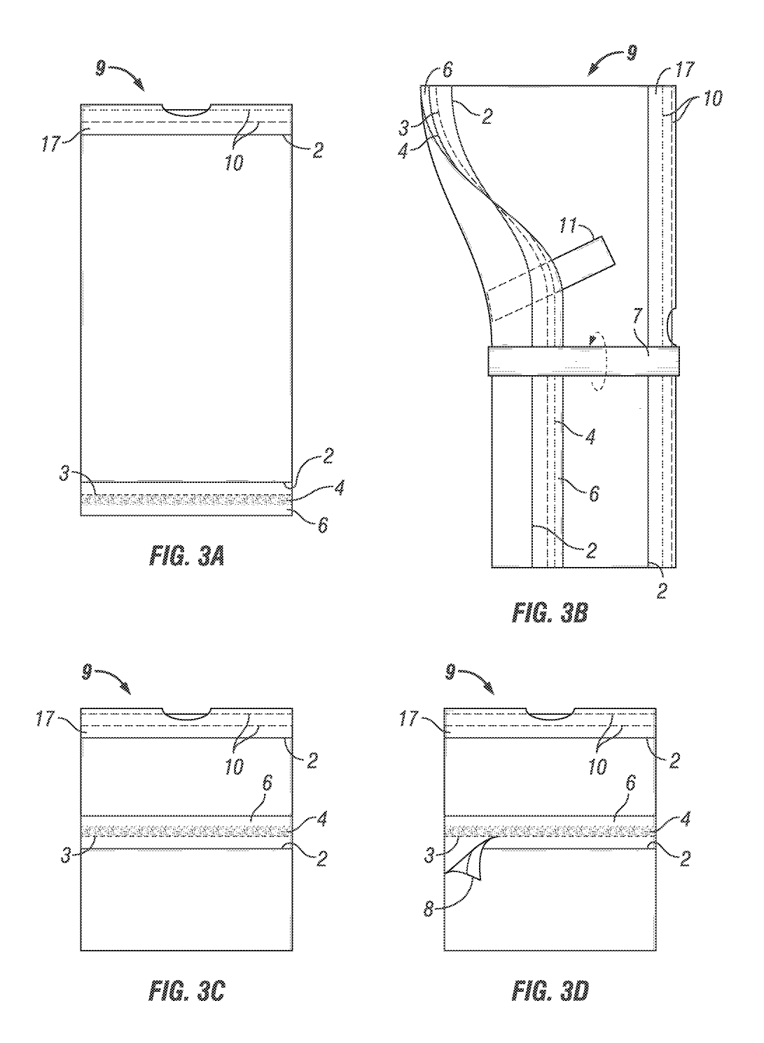

FIGS. 3A, 3B, 3C, 3D: Drawstring Bag: One Seal, One Perforation, One Permanent Adhesive

FIG. 3A depicts a drawstring style trash bag 9. The bag 9 has a seal 2 near the tail/bottom 6 that is the width of the bag with a perforated section 3 below it also the width of the bag. The perforated section 3 could technically be the width of the bag or anything less than the width of the bag. The perforation spacing and size may vary depending on the desired break force strength. Below the perforation 3 but above the bottom 6 of the bag a permanent adhesive 4 is applied to the entire width of the bag. The bag 9 also has a seal 2 toward the top of the bag that forms a hem pocket 17 which contains the drawstring 10 (usually a plastic strip).

Once the bag has these applications (FIG. 3A), the bag bottom 6 is run across a folding bar 11, or folding mechanism, and then through a set of nipped rollers 7 as shown in FIG. 3B. The nipped rollers 7 apply a pressure that adheres the bottom of the bag to the bag's body resulting in a lesser volume (FIG. 3C showing a horizontal view of the bag 9). The bottom of this smaller bag is the folded area. The volume of the smaller bag will vary based on where the original bag is folded. The suitable volume will be one that is ideal for a carry out bag. Once the bag has been used for its initial purpose, the perforation 3 can then be torn via bag corner 8 (FIG. 3D) to extend the bag back to its original length and volume. The end of the original bag (that was folded and adhered to the bag body) would remain attached to the side of the bag. The seal 2 above the perforation 3 (in the extended orientation) would become the bottom of the larger bag. The bag would now be a suitable size to be used as a trash bag. The drawstring 10 would be used as handles for both the initial use as a carry out bag and the secondary use as a trash bag.

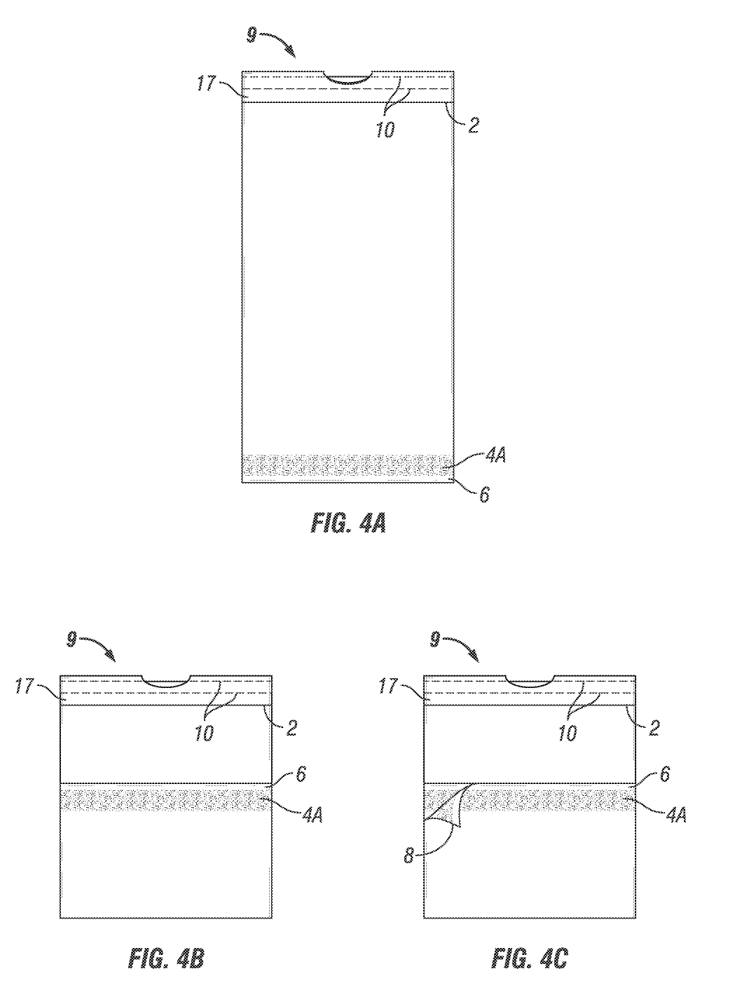

FIGS. 4A, 4B, 4C: Drawstring Bag: One Peelable Adhesive

FIG. 4A depicts a design similar to that of FIG. 3A in which a drawstring style trash bag 9 is folded and the bottom of the bag 6 is attached to the body, but is done so using a peelable adhesive 4A rather than a perforation (3 in FIG. 3A, but not shown in FIG. 4A because not used or needed). A peelable adhesive 4A is applied near the bottom of the bag 6 that is the width of the bag. The adhesive 4A could technically be the width of the bag or anything less than the width of the bag. Once the bag has these applications (FIG. 4A), the bag bottom is ran across a folding bar (not shown but similar to that shown as 11 in FIG. 3B) and then through a set of nipped rollers (7 pictured in FIG. 3B). The nipped rollers 7 apply a pressure that adheres the bottom of the bag to the bag's body resulting in a lesser volume (FIG. 4B). The bottom of this smaller bag is the folded area. The volume of the smaller bag will vary based on where the original bag is folded. The suitable volume will be one that is ideal for a carry out bag. Once the bag has been used for its initial purpose, the attached original bag bottom can be peeled from the bag body via bag corner 8 using peelable adhesive 4A (FIG. 4C) to extend the bag back to its original length and volume. The bottom of the original bag would function as the bottom of the extended bag. The bag would now be a suitable size to be used as a trash bag. The drawstring would be used as handles for both the initial use as a carry out bag and the secondary use as a trash bag.

The shear strength of the adhesive during first use needs to be capable of supporting the original load in the smaller volume bag and can after be peeled back in order to extend the bag to its original volume.

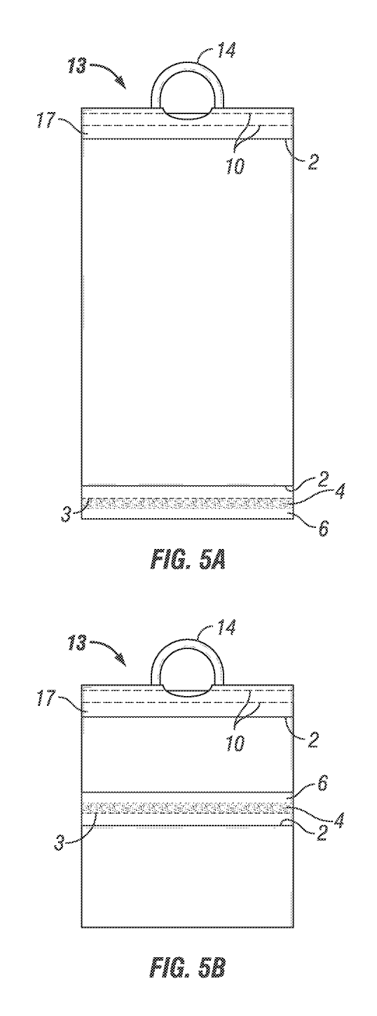

FIGS. 5A, 5B: Drawstring Bag Plus Handles Attached to Top

FIG. 5A depicts drawstring bag 13 with the addition of two looped handles 14 (could also be straight handles not shown) attached to the top of the bag. This drawstring bag with attached handles design would also be applicable to that depicted in FIGS. 4A, 4B, 4C and 4D (a folded drawstring bag attached with peelable adhesive), as well as FIGS. 10A, 10B, and 10C, FIGS. 11A, 11B, and 11C and FIGS. 12A, 12B, and 12C (although is not pictured herein.) Referring back to FIG. 5A, these handles 14 could be attached to the inside or the outside of the bag using an adhesive or seal (not shown). These handles could be any length and/or positioning on top of the bag in order to exist as the handles for the carry out bag. Once the bag has been used for its initial purpose, the bottom of original bag can be detached from the bag body (via perforation or peelable adhesive or flap) and be extended into its original length and volume. The bag would now be a suitable size to be used as a trash bag. The drawstrings could then be used to tie and carry the trash bag.

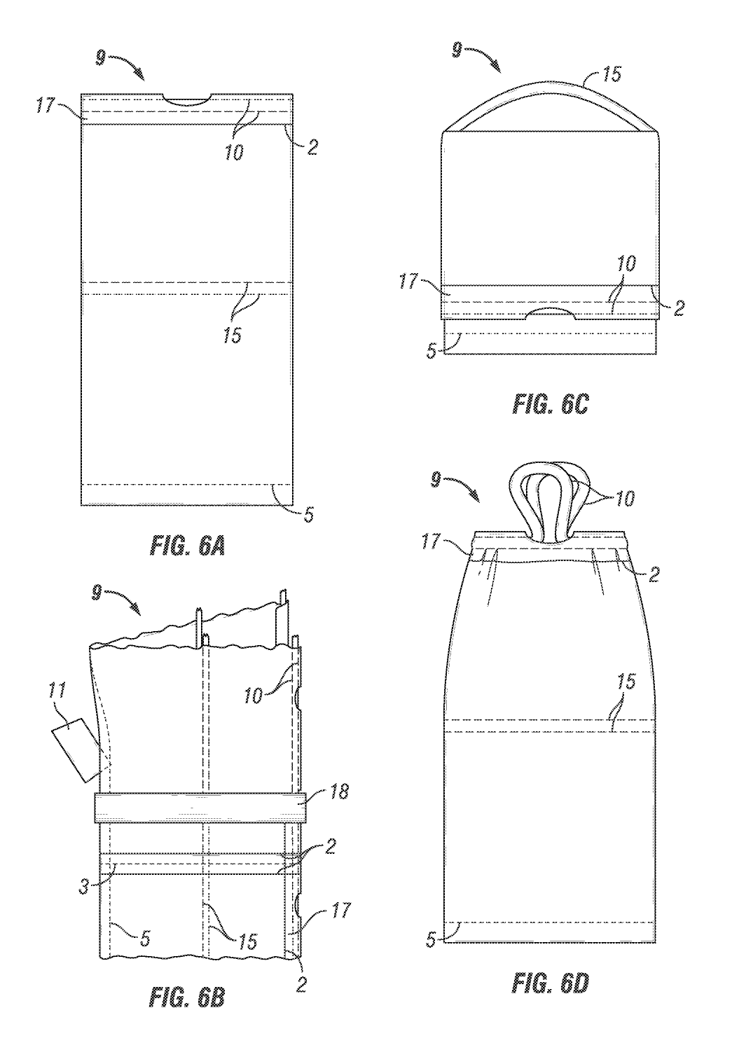

FIGS. 6A, 6B, 6C, 6D: Drawstring Bag: Bottom Gusset, Additional Handles Inside Bag.

This design demonstrates a bag that folds from the top down instead of from the bottom up as described in the former designs. FIG. 6A depicts a drawstring style trash bag 9 that has a gusseted bottom and a set of handles 15 (FIG. 6A, 6B, 6C, 6D) that are attached inside the bag. Seal 2 toward the top of the bag forms hem pocket 17 which houses drawstring 10. The handles 15 run the entire width of the bag and can be inserted anywhere in between the top and bottom of the bag. During the manufacturing process of the drawstring bag, two strips of plastic would be fed inside the bag (pictured as v-flap) somewhere in the middle of the bag at the same time the two pieces of draw tape are being inserted to create the drawstrings near the top of the bag (FIG. 6B). A gusset forming bar 11 pushes the bag bottom inwards to form a gusset 5, making a “W” shape. The depth of the gusset determines the surface area of the bottom of the bag. The film web then goes through a bag machine 18, which is not only pulling the film past the gusset forming bar 11 but also creases the gusset as it flattens the bag out (FIG. 6B). The bag machine 18 also applies seals 2 and perforation 3 to separate individual bags. This is also the mechanism in which the two plastic strips in the middle section of the bag are adhered to the bag sides (FIG. 6B). The top of the original bag is folded down to expose the inside handles and form a carry out sized bag (FIG. 6C). The volume of the smaller bag will vary based on where the inside handles are attached since they become the handles of the smaller bag. The bottom gusset formed creates a square bag bottom, which is suitable for carry out bags. Once the bag has been used for its initial purpose the top of the original bag can be folded back up to extend the bag to its original volume (FIG. 6D). The bag would now be a suitable size for use as a trash bag and the drawstring ties would be used as the handles.

This same concept is done with the two plastic strips attached the same way but on the outside of the bag. The top of the original bag could then be folded down into itself to form a smaller volume bag.

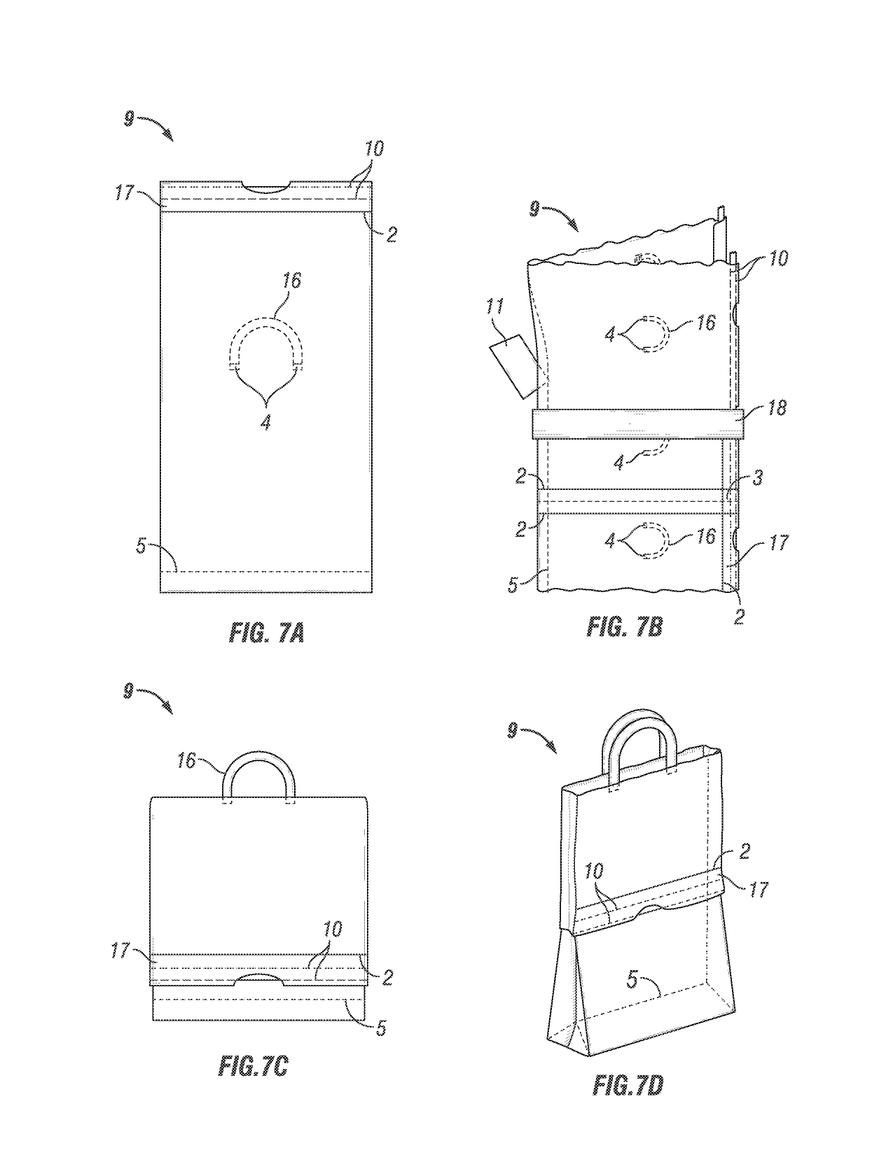

FIGS. 7A, 7B, 7C, 7D: Drawstring Bag: Bottom Gusset, Additional Looped Handles Inside Bag

This design is identical to that shown in FIGS. 6A-D except that the additional handles on the inside of the bag are looped handles 16 and do not span the full width of the bag. FIG. 7A shows a drawstring trash bag with the addition of a bottom gusset 5 and a pair of looped handles 16 (could also be straight handles, not shown) attached to the inside of the bag. These handles could be any length and/or positioning in between the top and bottom of the bag in order to exist as the handles for the carry out bag. The two looped handles 16 are attached inside the bag (pictured as “v-flap”) to the front and back panels via permanent adhesive 4 (FIG. 7B) (Could also be attached with a seal, not shown). The adhesive can be permanent or peelable, depending on use. A gusset forming bar 11 pushes the bag bottom inwards to form a gusset 5, making a “W” shape (FIG. 7D). The depth of the gusset 5 determines the surface area of the bottom of the bag. The film web then goes through a bag machine 18 (shown in FIG. 7B), which creases the gusset 5 as it flattens the bag out and applies pressure to firmly attach the inside handles 16 to the inside front and back panels (FIG. 7B). The bag machine 18 also applies seals 2 and perforation 3 to separate individual bags. The top of the original bag is folded down to expose the inside handles and form a carry out sized bag (FIG. 7C). The volume of the smaller bag will vary based on where the inside handles are attached since they become the handles of the smaller bag. The bottom gusset formed creates a square bag bottom, which is suitable for carry out bags. Once the bag has been used for its initial purpose the top of the original bag can be folded back up to extend the bag to its original volume. The bag would now be a suitable size for use as a trash bag and the drawstring ties would be used as the handles.

The same concept is done with two looped handles attached the same way but to the outside-middle of the bag. The top of the original bag could then be folded down into itself to form a smaller volume bag.

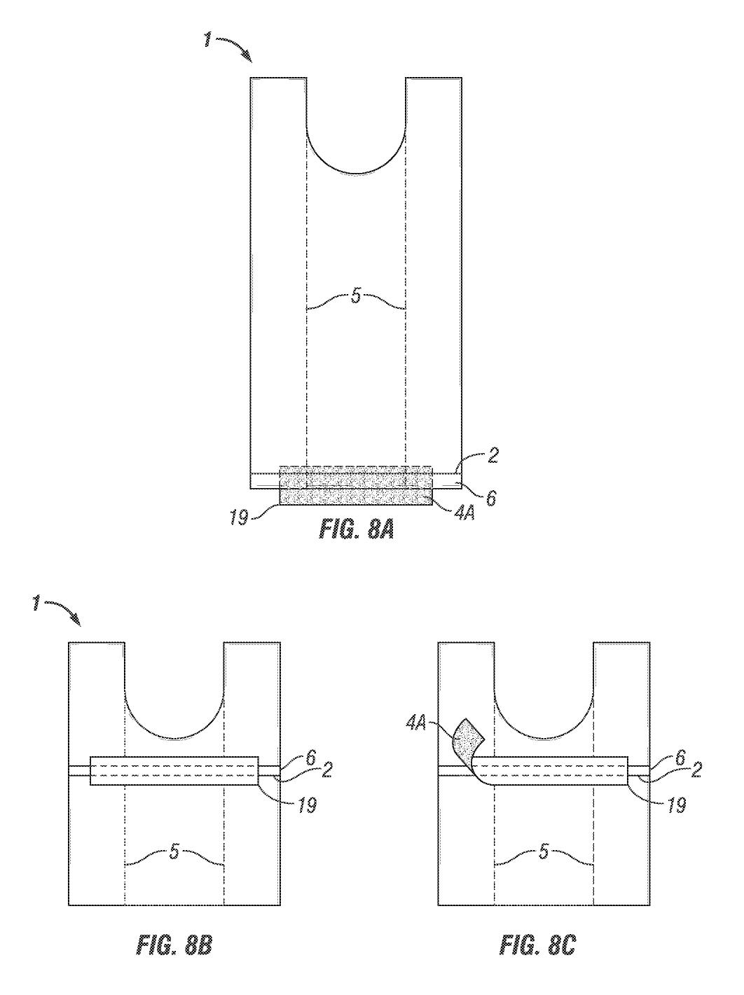

FIGS. 8A, 8B, 8C: T-Shirt Bag: One Peelable Flap

FIG. 8A depicts a design similar to that of FIG. 2 in which a T-shirt style trash bag 1 is folded and the bottom of the bag is attached to the body, but is done so using a flap 19 that has a peelable adhesive 4A on one side (FIG. 8A, 8B, 8C) rather than a peelable adhesive 4A alone (FIG. 2A, 2B, 2C). The bag has a seal 2 at the bottom/tail 6 of the bag that is the width of the bag. A peelable flap 19 is applied overlapping the seal 2/tail 6 that is not the width of the bag and bag tail 6. The adhesive flap 19 could technically be the width of the bag or anything less than the width of the bag (could also be multiple flaps, not shown). Once the bag has these applications (FIG. 8A), it is then folded through a pair of nipped rollers (pictured in FIG. 1B as 7). The nipped rollers apply a pressure that adheres the bottom of the bag to the bag's body via flap 19 resulting in a lesser volume (FIG. 8B). The bottom of this smaller bag is the folded area (below tail 6). The volume of the smaller bag will vary based on where the original bag is folded. The suitable volume will be one that is ideal for a carry out bag. Once the bag has been used for its initial purpose, the attached peelable flap 19 can be peeled from the bag body and bag bottom via flap 19 using peelable adhesive 4A (FIG. 8C) to extend the bag back to its original length and volume. The flap 19 would be completely removed from the bag. The seal 2 made at the bottom of the original bag would function as the bottom of the extended bag. The bag would now be a suitable size to be used as a trash bag.

The shear strength of the adhesive during first use needs to be capable of supporting the original load in the smaller volume bag and can after be peeled back in order to extend the bag to its original volume.

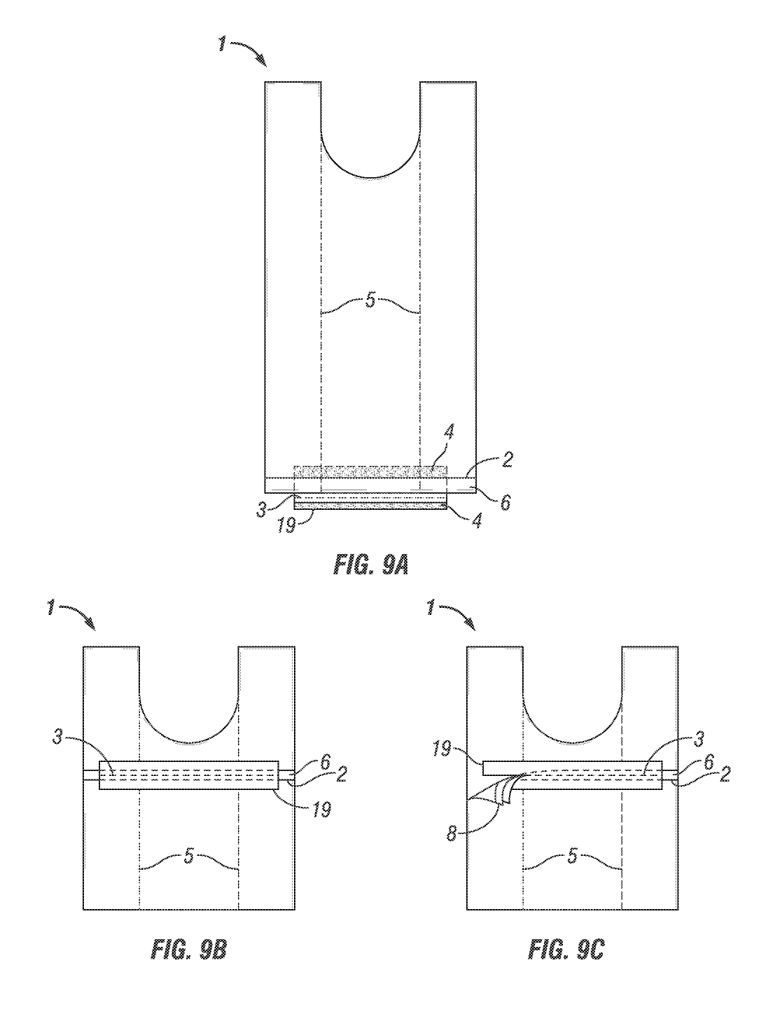

FIGS. 9A, 9B, 9C: T-Shirt Bag: One Permanently Adhered Perforated Flap

FIG. 9A depicts a design similar to that of FIG. 8 in which a T-shirt style trash bag 1 is folded and the bottom of the bag is attached to the body, but is done so using a flap 19 that has permeant adhesive strips 4 on the top and bottom edge and a perforation 3 in the middle (FIG. 9A, 9B, 9C) rather than a peelable flap (FIG. 8A, 8B, 8C). The perforation spacing and size may vary depending on the desired break force strength. The bag has a seal 2 at the bottom/tail 6 of the bag that is the width of the bag. A permanently adhered flap 19 is applied (FIG. 9A) overlapping the seal 2/tail 6 that is not the width of the bag and bag tail 6. The adhesive flap 19 could technically be the width of the bag or anything less than the width of the bag (could also be multiple flaps, not shown). Once the bag has these applications (FIG. 9A), it is then folded through a pair of nipped rollers (pictured in FIG. 1B as 7). The nipped rollers apply a pressure that adheres the bottom of the bag to the bag's body using flap 19 resulting in a lesser volume (FIG. 9B). The bottom of this smaller bag is the folded area (below tail 6). The volume of the smaller bag will vary based on where the original bag is folded. The suitable volume will be one that is ideal for a carry out bag. Once the bag has been used for its initial purpose, the perforation 3 can then be torn via bag corner 8 (FIG. 9C) to extend the bag back to its original length and volume. Half of flap 19 would remain attached to the side of the bag and the other half would remain attached to the bag bottom. The seal 2 made at the bottom of the original bag would function as the bottom of the extended bag. The bag would now be a suitable size to be used as a trash bag.

FIGS. 10A, 10B, 10C: Drawstring Bag: One Peelable Flap

FIG. 10A depicts a design similar to that of FIG. 4 in which a Drawstring style trash bag 1 is folded and the bottom of the bag is attached to the body, but is done so using a flap 19 that has a peelable adhesive 4A on one side (FIG. 10A, 10B, 10C) rather than a peelable adhesive 4A alone (FIG. 4A, 4B, 4C). A flap 19 with a peelable adhesive 4A applied to one side is attached to the bottom of the bag overlapping the bottom of the bag 6. The width of flap 19 is less than the width of bag bottom 6. The flap 19 could technically be the width of the bag or anything less than the width of the bag (could also be multiple flaps, not shown). Once the bag has these applications (FIG. 10A), the bag bottom is ran across a folding bar (not shown but similar to that shown as 11 in FIG. 3B) and then through a set of nipped rollers (7 pictured in FIG. 3B). The nipped rollers 7 apply a pressure that adheres the bottom of the bag to the bag's body via flap 19 resulting in a lesser volume (FIG. 10B). The bottom of this smaller bag is the folded area. The volume of the smaller bag will vary based on where the original bag is folded. The suitable volume will be one that is ideal for a carry out bag. Once the bag has been used for its initial purpose, the attached original bag bottom can be detached by peeling flap 19 via peel able adhesive 4A (FIG. 10C) from both the bag side and bag bottom completely removing it from the bag extending the bag back to its original length and volume. The bottom of the original bag would function as the bottom of the extended bag. The bag would now be a suitable size to be used as a trash bag. The drawstring would be used as handles for both the initial use as a carry out bag and the secondary use as a trash bag.

The shear strength of the adhesive during first use needs to be capable of supporting the original load in the smaller volume bag and can after be peeled back in order to extend the bag to its original volume.

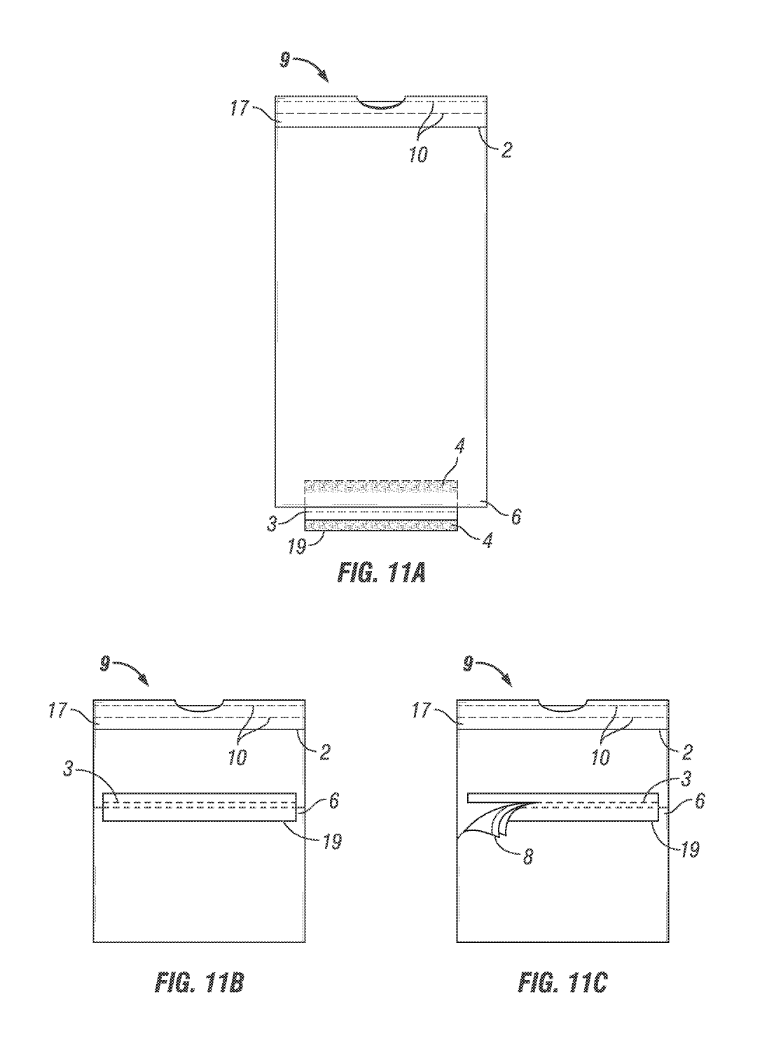

FIGS. 11A, 11B, 11C: Drawstring Bag: One Permanently Adhered Perforated Flap

FIG. 11A depicts a design similar to that of FIG. 10 in which a Drawstring style trash bag 1 is folded and the bottom of the bag is attached to the body, but is done so using a flap 19 that has permeant adhesive strips 4 on the top and bottom edge and a perforation 3 in the middle (FIG. 11A, 11B, 11C) rather than a peelable flap (FIG. 10A, 10B, 10C). The perforation spacing and size may vary depending on the desired break force strength. A flap 19 with the permeant adhesive strips 4 and perforation 3 is applied to the bag bottom overlapping the bottom of the bag 6 (FIG. 11A). The width of flap 19 is less than the width of bag bottom 6. The flap 19 could technically be the width of the bag or anything less than the width of the bag (could also be multiple flaps, not shown). Once the bag has these applications (FIG. 11A), the bag bottom is ran across a folding bar (not shown but similar to that shown as 11 in FIG. 3B) and then through a set of nipped rollers (7 pictured in FIG. 3B). The nipped rollers 7 apply a pressure that adheres the bottom of the bag to the bag's body via flap 19 resulting in a lesser volume (FIG. 11B). The bottom of this smaller bag is the folded area. The volume of the smaller bag will vary based on where the original bag is folded. The suitable volume will be one that is ideal for a carry out bag. Once the bag has been used for its initial purpose, the perforation 3 can then be torn via bag corner 8 (FIG. 11C) to extend the bag back to its original length and volume. Half of flap 19 would remain attached to the side of the bag and the other half would remain attached to the bag bottom. The bottom of the original bag would function as the bottom of the extended bag. The bag would now be a suitable size to be used as a trash bag. The drawstring would be used as handles for both the initial use as a carry out bag and the secondary use as a trash bag.

FIGS. 12A, 12B, 12C: Drawstring Bag: One Permanently Adhered Flap

FIG. 12A depicts a design similar to that of FIG. 10 in which a Drawstring style trash bag 1 is folded and the bottom of the bag is attached to the body, but is done so using a flap 19 that has permeant adhesive 4 on one side (FIG. 12A, 12B, 12C) rather than a peelable flap (FIG. 10A, 10B, 10C). A flap 19 with a permanent adhesive 4 applied to one side is attached to the bottom of the bag overlapping the bottom of the bag 6. The width of flap 19 is less than the width of bag bottom 6. The flap 19 could technically be the width of the bag or anything less than the width of the bag (could also be multiple flaps, not shown). Once the bag has these applications (FIG. 12A), the bag bottom is ran across a folding bar (not shown but similar to that shown as 11 in FIG. 3B) and then through a set of nipped rollers (7 pictured in FIG. 3B). The nipped rollers 7 apply a pressure that adheres the bottom of the bag to the bag's body via flap 19 resulting in a lesser volume (FIG. 12B). The bottom of this smaller bag is the folded area. The volume of the smaller bag will vary based on where the original bag is folded. The suitable volume will be one that is ideal for a carry out bag. Once the bag has been used for its initial purpose, the flap 19 can then be torn via bag corner 8 (FIG. 12C) to extend the bag back to its original length and volume. Half of flap 19 would remain attached to the side of the bag and the other half would remain attached to the bag bottom. The bottom of the original bag would function as the bottom of the extended bag. The bag would now be a suitable size to be used as a trash bag. The drawstring would be used as handles for both the initial use as a carry out bag and the secondary use as a trash bag.

TABLE 1
Drawings Elements List

| Drawing element number | Description |
|---|---|
| 1 | T-shirt bag |
| 2 | Seal |
| 3 | Perforation |
| 4 | Permanent adhesive |
| 4A | Peelable Adhesive |
| 5 | Gusset |
| 6 | Tail or bottom of bag |
| 7 | Nip rollers |
| 8 | Bag/corner edge |
| 9 | Drawstring bag |
| 10 | Drawstring |
| 11 | Folding bar |
| 13 | Drawstring bag with handles |
| 14 | Handles |
| 15 | Internal handles |
| 16 | Loop internal handles |
| 17 | Hem/drawstring pocket |
| 18 | Bag machine |
| 19 | Flap |

### Example

The bag described in this application can be made by first making a master roll of blown film from a product like Dow's DOWLEX 2020G resin. This resin has a MI of 0.5 g/10 min and a density of 0.920 g/cm³. A 1 mil thick blown film can be made using a 2.75 blow up ratio (BUR). The collapsed bubble would have a width of 58 inches which could then be slit in the middle to form two master rolls at once, both of which each would be 29 inches wide. This would be the desired width to form a 13 gallon drawstring trash bag. This roll could then be placed on a bag making machine like a 1270GDS rotary bag machine made by CMD. This machine unwinds the film from the master roll pulling it through the machine. The top two inches of the cut edges of the master roll are folded over 180 degrees and sealed forming a hems in which draw tapes are inserted. This machine then seals and perforates the side seals of each bag. The perforations between bags keep the film web in tack so the process remains continually running at speeds as high as 600 ft/min. After the bags are formed the web of perforated bags could be pulled through a set of folding frames. Each folding frame can fold the film web in half or less than half. Behind the first folding frame an adhesive application system could be placed to apply a 0.25 inch wide bead of a peal able adhesive just above the bottom edge of the bag as it is being folded. Immediately after the folding frame the folded web of bags is pulled through a set of nipped rollers that would apply pressure insuring a good bond between the adhered film layers. The web of bags could then pass through the second folding frame further reducing the web width. The bags could then be wound up on a roll at which point the perforations between bags could be separated. One would now have a 13 gallon drawstring trash bag that has been shortened and could be returned back to its original length by pealing the bag bottom from the bag side wall at the adhesive interface.

We claim:

1. A thermoplastic bag comprising at least one layer, wherein the at least one layer comprises:
a first sidewall of flexible thermoplastic material;
a second sidewall of flexible thermoplastic material over-laying and joined to the first sidewall to form a first sidewall seam along a first side edge, to form a second sidewall seam along an opposite second side edge, and a closed bottom edge, the first and second sidewalls unjoined along respective top edges to define an opening opposite the closed bottom edge for accessing an interior volume;
wherein the interior volume is adjusted by folding the closed bottom edge of the bag up at least a portion of at least one bag sidewall toward the top edges and attaching the closed bottom edge to said at least one of the bag sidewalls.

2. The thermoplastic bag of claim 1, wherein the closed bottom edge is attached to at least one of the bag sidewalls in a manner that can be detached at a later time to return the bag to its original interior volume.

3. The thermoplastic bag of claim 1, wherein at least one of the sidewalls forms a hem having a top length and extending along the open top end disposed opposite the closed bottom edge, the hem having a bottom length and at least one hem seal, the hem including one or more draw tape notches and at least one draw tape within the hem.

4. The thermoplastic bag of claim 1, wherein the closed bottom edge of the bag is folded up from about 5% to about 95% of a height of at least one bag sidewall toward the top edges and attaching the closed bottom edge to said at least one of the bag sidewall.

5. The thermoplastic bag of claim 1, wherein the closed bottom edge of the bag is attached to one of the bag sidewalls with a strip of continuous or discontinuous peelable adhesive that runs the width of the bag, adjacent to the bottom edge of the bag.

6. The thermoplastic bag of claim 1, wherein the closed bottom edge of the bag is formed using an adhesive interface and then detached from the bag sidewall by pulling the bottom edge and peeling the bag apart at the adhesive interface.

7. A plurality of thermoplastic bags comprising the bag of claim 1, wherein the plurality of bags is folded, overlapped and rolled up as a roll.

8. The thermoplastic bag of claim 1, wherein a bottom seal running the width of the bag and parallel to the bottom edge of the bag is added from about 0.125 to about 10 inches above the edge of the bag bottom.

9. The thermoplastic bag of claim 8, wherein a perforation running the width of the bag and parallel to the closed bottom edge of the bag is added just below the seal.

10. The thermoplastic bag of claim 9, wherein a permanent adhesive running the width of the bag and parallel to the closed bottom edge of the bag is added just below the perforation.

11. The thermoplastic bag of claim 9, wherein the closed bottom edge of the bag is detached from the bag sidewall by tearing the perforation.

12. The thermoplastic bag of claim 1, wherein the closed bottom edge of the bag is attached to one of the bag sidewalls with at least one permanent adhesive strip.

13. The thermoplastic bag of claim 1, wherein the closed bottom edge of the bag is formed using a permanent adhesive strip and then detached from the bag sidewall by tearing the permanent adhesive strip leaving half attached to the bag side wall.

14. A thermoplastic film bag having front and rear walls, each of said front and rear walls having first and second side edges, a top edge and a bottom edge;
said front and rear walls being integrally joined at their first and second side edges and secured together at their bottom edge by a lower seam across the width of said bags to form a closed bottom edge; the front and rear walls unjoined along respective top edges to define an opening opposite the bottom edge for accessing an interior volume;
wherein the interior volume is adjusted by folding the closed bottom edge of the bag up at least a portion of at least one bag front or rear sidewalls (Front or Rear walls) toward the top edges and attaching the closed bottom edge to said at least one of the bag front or rear sidewalls.

15. The thermoplastic bag of claim 14, wherein the bottom edge is attached to at least one of the bag front or rear sidewalls in a manner that can be detached at a later time to return the bag to its original volume.

16. The thermoplastic bag of claim 14, wherein the closed bottom edge of the bag is folded up from about 5% to about 95% of a height of at least one bag front or rear sidewall toward the top edges and attaching the closed bottom edge to said at least one of the bag front or rear sidewalls.

17. The thermoplastic bag of claim 14, wherein the top edge of the front and rear walls are secured together by a upper seam across the width of said bags;
each of said bags having longitudinally oriented side gussets adjacent said first and second side edges;
a U-shaped cut-out, said U-shaped cut-out being disposed in an upper portion of said bag and commencing at a first point along said upper seam spaced inwardly from said first side edge and extending to a second point along the upper seam spaced inwardly from said second side edge, said cut-out extending downwardly toward said bottom edges, thereby forming an open mouth portion and a pair of bag handles.

18. The thermoplastic bag of claim 14, wherein at least one of the front and rear side walls edges are secured together with a seam the length of the said bags.

19. The thermoplastic bag of claim 14, wherein each of said bags has longitudinally oriented side gussets adjacent said first and second side edges.

20. The thermoplastic bag of claim 14, wherein the closed bottom edge of the bag is attached to one of the bag front or rear sidewalls with a strip of continuous or discontinuous peelable adhesive that runs the width of the bag, adjacent to the bottom edge of the bag.

21. The thermoplastic bag of claim 14, wherein the closed bottom edge of the bag is formed using an adhesive interface and then detached from the bag front or rear sidewall by pulling the bottom edge and peeling the bag apart.

22. The thermoplastic bag of claim 14, wherein the closed bottom edge of the bag is attached to one of the bag front or rear sidewalls with at least one permanent adhesive strip.

23. The thermoplastic bag of claim 22, wherein the closed bottom edge of the bag is detached from the bag sidewall by tearing the permanent adhesive strip leaving half attached to the bag body and half attached to the bag front or rear sidewall.

24. The thermoplastic bag of claim 14, wherein a perforation running the width of the thermoplastic bag and parallel to the bottom edge of the bag is added just below the seal.

25. The thermoplastic bag of claim 24, wherein a permanent adhesive running the width of the bag and parallel to the bottom edge of the bag is added just below the perforation.

26. The thermoplastic bag of claim 14, wherein the closed bottom edge of the bag is detached from the bag front or rear sidewall by tearing the perforation.

27. The thermoplastic bag of claim 14, wherein the bag is individually folded.

28. A plurality of thermoplastic bags comprising the bag of claim 14, wherein the plurality of bags are individually stacked and wicked together.

29. The bag of claim 17, wherein having a slotted tab is integrally attached to the front and rear walls at the top edge of the bag in the center of the handles.

30. A plurality of thermoplastic bags comprising the bag of claim 29, wherein the plurality of bags are individually stacked and attached by their slotted tab so that the stacked bags are hung on a rack and individually dispensed.
